(19) United States
(12) Patent Application Publication
(10) Pub. No.: US 2023/0244843 A1
(43) Pub. Date: Aug. 3, 2023

(54) METHOD FOR SIMULATING SYSTEM AND ASSOCIATED ELECTRONIC DEVICE

(71) Applicant: Realtek Semiconductor Corp., HsinChu (TW)

(72) Inventors: Shih-Hung Wang, HsinChu (TW); Chia-Lin Tu, HsinChu (TW); Ting-Ying Wu, HsinChu (TW)

(73) Assignee: Realtek Semiconductor Corp., HsinChu (TW)

(21) Appl. No.: 18/098,674

(22) Filed: Jan. 18, 2023

(30) Foreign Application Priority Data
Jan. 28, 2022 (TW) 111103992

(51) Int. Cl. G06F 30/367; G06F 1/18

(52) U.S. Cl. CPC G06F 30/367; G06F 1/189

(57) ABSTRACT

The present invention provides an electronic device including a storage device and a processor. The storage device includes a program code and a database, wherein the database includes a plurality of combinations of printed circuit boards and packages and a plurality of channel models. The processor is configured to execute the program code to perform the steps of: obtaining a first combination of the plurality of combinations of printed circuit boards and packages from the database; obtaining a first channel model of the plurality of channel models from the database, wherein the first channel model is generated according to the first combination; determining first die information; and performing simulation to generate characteristics of a power delivery network and a voltage drop of a system according to the first channel model and the first die information.

### BACKGROUND OF THE INVENTION

### 1. Field of the Invention

The present invention relates to a method for simulating a system.

### 2. Description of the Prior Art

In current design of a system including printed circuit board(s), package(s) and chip(s), if a designer wants to determine whether a voltage drop of the system meets the specifications, it is necessary to have complete data in the middle and late stages of system design, that is, complete chip power models, package designs, and printed circuit board designs are available for simulation in the middle and late stages of system design. However, if the simulation result indicates that the system design cannot meet the specifications, it will take more time to restart the design, increasing the burden on the designer.

### SUMMARY OF THE INVENTION

It is therefore an objective of the present invention to provide a system simulation method, which can evaluate a power delivery network (PDN) or voltage drop of the system through a simple simulation method in the early stage of chip power development, to determine whether the planned/designed printed circuit board, package and chip power models meet the specifications, to solve the problems described in the prior art.

According to one embodiment of the present invention, an electronic device comprising a storage device and a processor is disclosed. The storage device comprises a program code and a database, wherein the database comprises a plurality of combinations of printed circuit boards and packages and a plurality of channel models. The processor is configured to execute the program code to perform the steps of: obtaining a first combination of the plurality of combinations of printed circuit boards and packages from the database; obtaining a first channel model of the plurality of channel models from the database, wherein the first channel model is generated according to the first combination; determining first die information; and performing simulation to generate characteristics of a power delivery network and a voltage drop of a system according to the first channel model and the first die information.

According to one embodiment of the present invention, a method for simulating a system comprises the steps of: obtaining a first combination of a plurality of combinations of printed circuit boards and packages from a database; obtaining a first channel model of a plurality of channel models from the database, wherein the first channel model is generated according to the first combination; determining first die information; and performing simulation to generate characteristics of a power delivery network and a voltage drop of the system according to the first channel model and the first die information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to one embodiment of the present invention.

FIG. 2 is a flowchart of a method for simulating a system.

FIG. 3 is a diagram of a simulation result of characteristics of the power delivery network.

FIG. 4 is a diagram of a simulation result of a voltage drop of the system.

### DETAILED DESCRIPTION

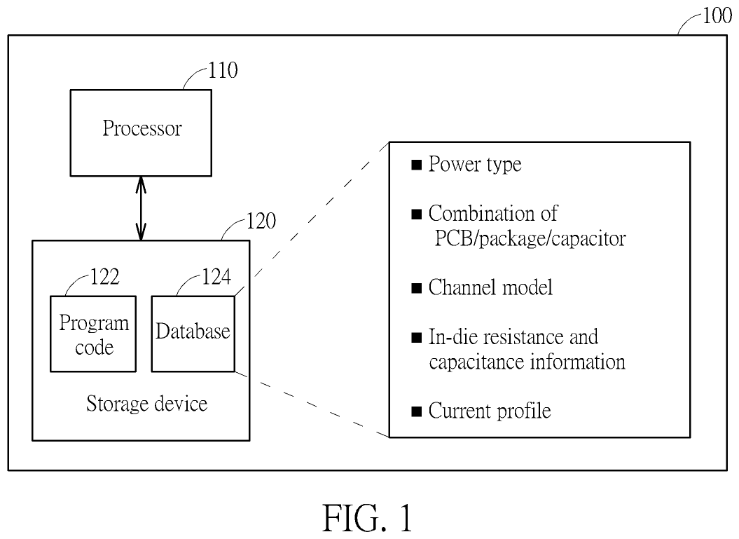

FIG. 1 is a diagram illustrating an electronic device 100 according to one embodiment of the present invention, wherein the electronic device 100 is used to simulate the power-related performance of a system in the early stage of chip development, the system includes a printed circuit board, a package and a die fabricated on the printed circuit board, and the electronic device 100 can be a desktop computer, a notebook, or any electronic device that can simulate the system. As shown in FIG. 1, the electronic device 100 comprises a processor 110 and a storage device 120, wherein the storage device 120 can be any non-volatile storage device, and the storage element 120 stores at least a program code 122 and a database 124. In this embodiment, the database 124 includes the contents and simulation results of the system design in the past. Specifically, the database 124 may include various power types, such as core power, input/output power (IO power), central processing unit, etc.; the database 124 may include various combinations of printed circuit boards, packages and capacitors; the database 124 may include various channel models, where a channel model is a characteristic of a power delivery path in a system, such as a relationship between the impedance and frequency of the power delivery path in the case of various combinations of printed circuit boards, packages and capacitors; the database 124 may include in-die resistance and capacitance information, wherein the in-die resistance and capacitance information may be obtained by using an equivalent circuit model inside the die, such as relationship between impedance and frequency generated by the simulation using the resistance value and capacitance value of the equivalent circuit inside the die; and the database 124 may include a current profile of the die.

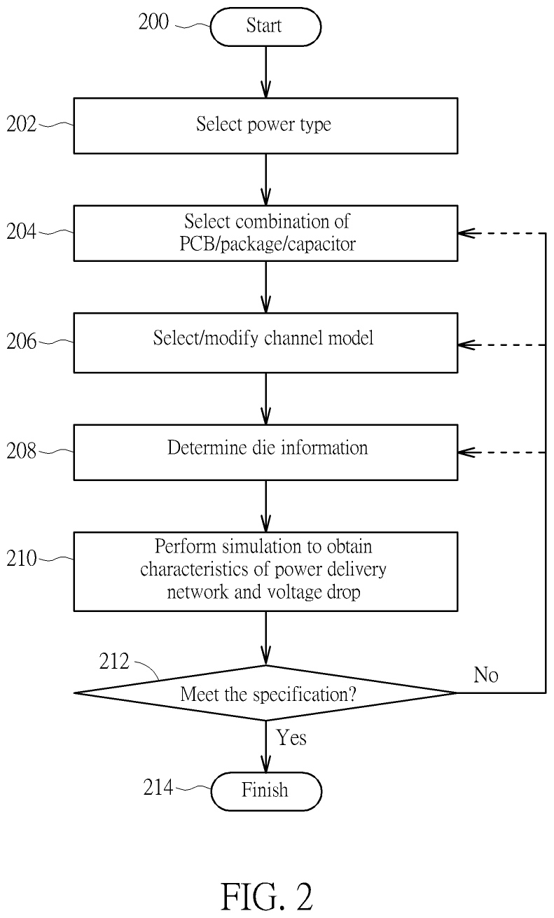

In the operation of the electronic device 100, the processor 110 reads the program code 122 from the storage device 120, and executes the program code 122 to start the system simulation. FIG. 2 shows a flow of the system simulation. In Step 200, the flow starts, and the processor 110 has successfully executed the program code 122, and displays a user interface on a display panel of the electronic device 100. In Step 202, the user selects a power type from the database 124 through the user interface. In Step 204, the user selects a combination of printed circuit board, package and capacitor from the database 124 through the user interface, wherein the user can select a combination of printed circuit board, package and capacitor, from the database 124, that is closer in overall design of the currently designed die, printed circuit board and package. In Step 206, the user selects a channel model, wherein the selected channel model may be generated based on the combination of printed circuit board, package and capacitor selected in Step 204. In this embodiment, the channel model can include an equivalent resistance and inductance, S-parameters used to represent the behavior of the circuits under different frequencies, a Simulation Program with Integrated Circuit Emphasis (SPICE) model, or information that can represent a relationship between the impedance and frequency of the combination of the printed circuit board, package and capacitor. In Step 208, the user determines the die information through the user interface, wherein the die information can include the in-die resistance and capacitance information, and the user can input the in-die resistance and capacitance information according to the actual design, or select a closer one from the database 124. In addition, the die information can also include current profile, wherein the current profile can be inputted by the user according to the actual design, or the user can select the current profile closer to the actual design from the database 124.

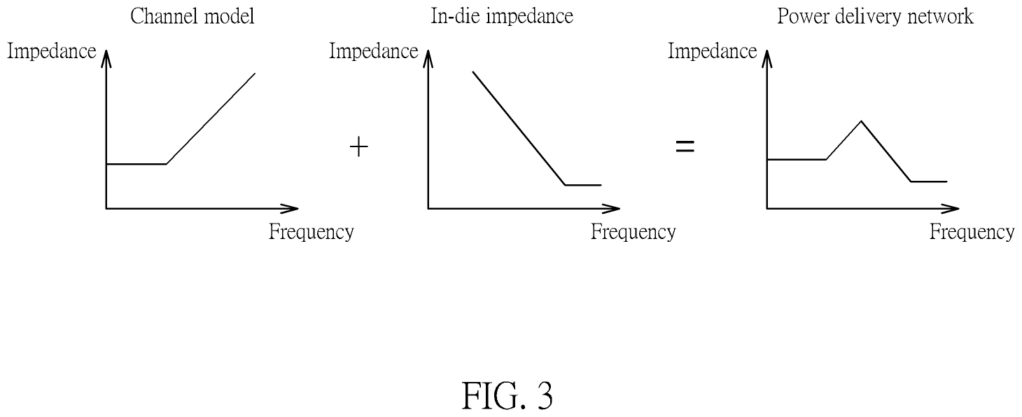

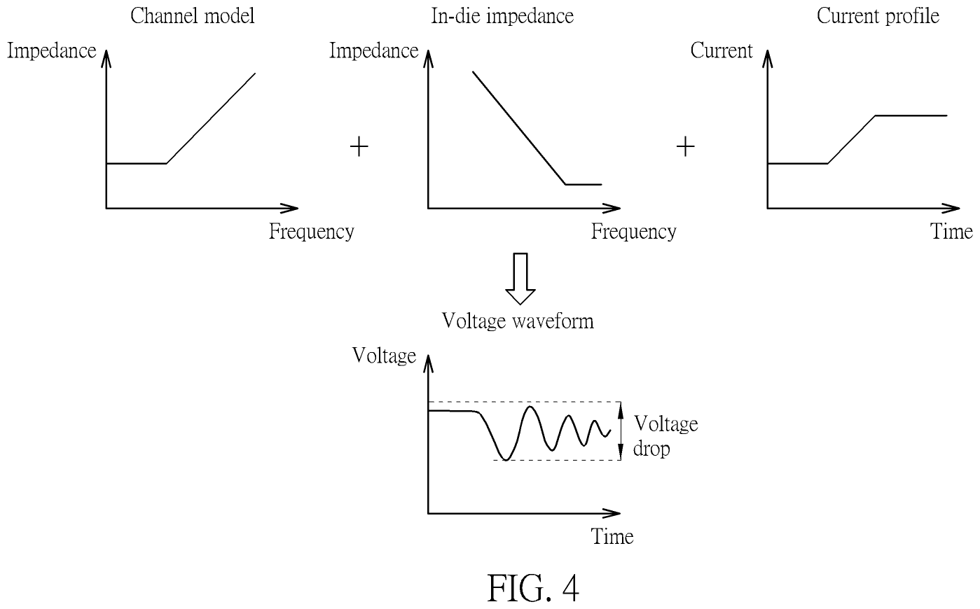

In Step 210, the processor 110 performs simulation to obtain characteristics of the power delivery network and voltage drop according to the combination of printed circuit board, the package and capacitor, the channel model, the in-die resistance and capacitance information, and the current profile selected by the user in Steps 204, 206 and 208. Specifically, referring to FIG. 3, the channel model can be a relationship between impedance and frequency generated by the equivalent resistance and inductance of the printed circuit board and the package, and the in-die resistance and capacitance information can be a relationship between impedance and frequency, and the processor 110 can generate the characteristics of the power delivery network accordingly. In addition, referring to FIG. 4, the current profile can be the relationship between current and time, and the processor 110 can obtain the voltage waveform of the system according to the channel model, the in-die resistance and capacitance information and the current profile, and the voltage drop of the system can be obtained by calculating a difference between an input voltage (e.g., the upper dotted line in FIG. 4) and the minimum value of the voltage waveform.

In Step 212, the processor 110 determines whether the characteristics of the power delivery network of the system and the voltage drop reach the targets, that is, whether the characteristics of the power delivery network and voltage drop meet the expected standard, if yes, the flow enters Step 214; and if not, the flow goes back to Step 204, Step 206 or Step 208 to select another combination of printed circuit board, package and capacitor, select another channel model, or determine another on-die resistance and capacitance information, or determine another current profile, for the simulation in Step 210. Specifically, another channel model can be selected and simulated with the currently used die information to generate the characteristics of the power delivery network and the voltage drop, wherein the other channel model can be modified by the user or obtained from the database 124 to select the channel model corresponding to another combination of printed circuit board, package and capacitor; another die information is selected to simulate with the currently used channel model to generate the characteristics of the power delivery network and the voltage drop.

In Step 214, the simulation finishes, the user can confirm that the combination of printed circuit board, package and capacitor selected in Step 204 is a feasible design, and the in-die resistance and capacitance information and current profile determined in Step 208 can achieve the target.

Briefly summarized, in the system simulation method of the present invention, by establishing contents and simulation results of the system design in the past in the database, the designer can use a simple simulation method to evaluate the characteristics of the power delivery network and voltage drop of the system in the early stage of power development and before the complete design of the related printed circuit boards and packages, to determine whether the selected printed circuit board, package and die model meet the specification. By using the present invention, the suitable printed circuit boards and packages can be obtained, and the characteristics or voltage drop of related power delivery networks can be known in the early stage of a power development of the chip, so as to reduce the burden of subsequent system design.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device, comprising:
a storage device comprising a program code and a database, wherein the database comprises a plurality of combinations of printed circuit boards and packages and a plurality of channel models; and
a processor, coupled to the storage device, configured to execute the program code to perform the steps of:
obtaining a first combination of the plurality of combinations of printed circuit boards and packages from the database;
obtaining a first channel model of the plurality of channel models from the database, wherein the first channel model is generated according to the first combination;
determining first die information; and
performing simulation to generate characteristics of a power delivery network and a voltage drop of a system according to the first channel model and the first die information.

2. The electronic device of claim 1, wherein the first die information comprises in-die resistance and capacitance information and a current profile.

3. The electronic device of claim 1, wherein the first channel model comprises an equivalent resistance and inductance, S-parameters used to represent behaviors of the first combination under different frequencies, or a Simulation Program with Integrated Circuit Emphasis (SPICE) model.

4. The electronic device of claim 1, wherein the processor executes the program code to further perform the steps of:
determining whether the characteristics of the power delivery network and the voltage drop meet a specification;
in response to the characteristics of the power delivery network and the voltage drop not meeting the specification, generating a second channel model different from the first model; and
performing the simulation to generate the characteristics of the power delivery network and the voltage drop of the system according to the second channel model and the first die information.

5. The electronic device of claim 1, wherein the processor executes the program code to further perform the steps of:
determining whether the characteristics of the power delivery network and the voltage drop meet a specification;
in response to the characteristics of the power delivery network and the voltage drop not meeting the specification, selecting a second combination of the plurality of combinations of printed circuit boards and packages from the database;
selecting a second channel model of the plurality of channel models from the database, wherein the second channel model is generated according to the second combination; and
performing the simulation to generate the characteristics of the power delivery network and the voltage drop of the system according to the second channel model and the first die information.

6. The electronic device of claim 1, wherein the processor executes the program code to further perform the steps of:
determining whether the characteristics of the power delivery network and the voltage drop meet a specification;
in response to the characteristics of the power delivery network and the voltage drop not meeting the specification, determining second die information; and
performing the simulation to generate the characteristics of the power delivery network and the voltage drop of the system according to the first channel model and the second die information.

7. A method for simulating a system, comprising:
obtaining a first combination of a plurality of combinations of printed circuit boards and packages from a database;
obtaining a first channel model of a plurality of channel models from the database, wherein the first channel model is generated according to the first combination;
determining first die information; and
performing simulation to generate characteristics of a power delivery network and a voltage drop of the system according to the first channel model and the first die information.

8. The method of claim 7, wherein the first die information comprises in-die resistance and capacitance information and a current profile.

9. The method of claim 7, wherein the first channel model comprises an equivalent resistance and inductance, S-parameters used to represent behaviors of the first combination under different frequencies, or a Simulation Program with Integrated Circuit Emphasis (SPICE) model.

10. The method of claim 7, further comprising:
determining whether the characteristics of the power delivery network and the voltage drop meet a specification;
in response to the characteristics of the power delivery network and the voltage drop not meeting the specification, generating a second channel model different from the first model; and
performing the simulation to generate the characteristics of the power delivery network and the voltage drop of the system according to the second channel model and the first die information.

11. The method of claim 7, further comprising:
determining whether the characteristics of the power delivery network and the voltage drop meet a specification;
in response to the characteristics of the power delivery network and the voltage drop not meeting the specification, selecting a second combination of the plurality of combinations of printed circuit boards and packages from the database;
selecting a second channel model of the plurality of channel models from the database, wherein the second channel model is generated according to the second combination; and
performing the simulation to generate the characteristics of the power delivery network and the voltage drop of the system according to the second channel model and the first die information.

12. The method of claim 7, further comprising:
determining whether the characteristics of the power delivery network and the voltage drop meet a specification;
in response to the characteristics of the power delivery network and the voltage drop not meeting the specification, determining second die information; and
performing the simulation to generate the characteristics of the power delivery network and the voltage drop of the system according to the first channel model and the second die information.
